(19) United States
(12) Patent Application Publication
(10) Pub. No.: US 2016/0113431 A1
(43) Pub. Date: Apr. 28, 2016

(54) HEATING MEDIUM GENERATING APPARATUS AND HEATING TREATMENT APPARATUS INCLUDING THE HEATING MEDIUM GENERATING APPARATUS

(71) Applicants: National Agriculture and Food Research Organization, Ibaraki (JP); Taiyo Seisakusho Co., Ltd., Hokkaido (JP)

(72) Inventors: Itaru SOTOME, Ibaraki (JP); Seiichiro ISOBE, Ibaraki (JP); Yukio OGASAWARA, Hokkaido (JP)

(73) Assignees: National Agriculture and Food Research Organization, Ibaraki (JP); Taiyo Seisakusho Co., Ltd., Hokkaido (JP)

(21) Appl. No.: 14/345,732

(22) PCT Filed: Mar. 5, 2014
(86) PCT No.: PCT/JP2014/055594

§ 371 Date: Mar. 19, 2014

(30) Foreign Application Priority Data
Mar. 5, 2013 (JP) 2013-043024

(51) Int. Cl. A47J 27/04; F22B 3/00

(52) U.S. Cl. CPC A47J 27/04; F22B 3/00; A47J 2027/043

(57) ABSTRACT

It may correspond to the demand for cost reduction of the heating treatment apparatus including heating medium generating apparatus capable of generating a heat processable heating medium foods with disclosed high quality. Further, it is to realize energy savings, the shortening of the apparatus manufacturing process and time and weight.

[Means to dissolve] comprising the exterior body 5 having a insulation; a far-infrared radiation heater 11 disposed in the exterior body 5; the heat exchange pipe 13 provided with water supply unit 18 and a water discharger 19, arranged from one end to the other end of the exterior body 5, and the heating medium supplied water passes through the inner space thereof; and first reflecting member 23 for reflecting far-infrared radiation rays radiated from the far-infrared radiation heater 11 and enabling to reflect it to the heat exchange pipe 13.

### FIELD OF THE INVENTION

The present invention, for example, is related to the heating medium generating apparatus capable of generating heating medium for enabling heat processing foods and the like with a high quality and to the heating treatment apparatus capable of generating heating medium for enabling heat processing foods and the like with a high quality by using the heating medium generating apparatus.

### BACKGROUND OF THE INVENTION

Conventionally, the present inventors, have the aim of developing and patenting new heating treatment method and new heating treatment apparatus for adjusting the heating treatment chamber to the state of the heating treatment atmosphere that the heating medium (gas-liquid mixture) are mixed.

For this purpose, they boil water at a predetermined temperature and predetermined pressure as high-quality cooking of applying superheated steam heating technology and the food processing system to generate the heating medium (gas-liquid mixture) consisting of superheated steam and hot fine water droplets, and finally spray the heating medium (gas-liquid mixture) into the heating treatment chamber that is heated to a predetermined temperature. (see Patent Document 1).

In addition, they also developed for the method and apparatus to generate saturated steam and superheated steam in the same apparatus other than new heating medium as the optimum heating treatment in accordance with the heated object and purpose, and then have filed a patent application therefor, (see Patent Document 2)

In addition, they also developed a stable controlling method by for revealing the conditions for generating new heating medium (discovery of the critical internal pressure), and then have filed a patent application, (see Patent Document 3)

Further, they also developed for the generator of new heating medium that is unitized and connectable to various apparatus, and then have filed a patent application, (see Patent Document 4)

The heating medium generator and heating treatment equipment that the present inventors have developed earlier is a thing that can achieve the initial object sufficiently, however recently there is a demand for compactification and low cost of the entire apparatus, thus the present inventors led, to the development of the present invention to meet he demands of low-cost and compact this.

In the heating medium generating apparatus disclosed in Patent Document 4 that the present inventors have previously proposed, there is electric heat generator or a steam jet generator, In the electric heat generator, electrically-heated wire has been used as the heating element in the apparatus.

That is the electric heater formed into a coil shape having a diameter larger than the heat exchanger pipes is attached in close contact with the outer periphery of the heat exchange pipe formed into a coal shape and is disposed within the housing of the insulating structure. And it was constructed by filling heat conducting cement having a high thermal conductivity for example, made by Thermon Manufacturing Company in U.S.A.) in the housing.

Thus, in Patent Document 4, it has been attempted to transfer heat by electric heat conduction between the electrically-heated wire and the heat exchange pipe.

However, in the heating medium generating apparatus and the heating treatment apparatus using the heating medium generating apparatus described above, the price of the electrically-heated wire and the heat conducting cement is expensive, and further it takes a time for the manufacturing process, for example, filling operation of the heat conducting cement into the housing and curing operation thereof.

As a result of that, it is difficult to reduce the product cost of the heating treatment apparatus and the heating treatment apparatus using the heating medium generating apparatus.

Further, it has not been responding to the demand for compactification because it is filled with heat conducting cement and thus the total weight of the entire apparatus is bulky.

### RELATED ART

### Patent Document

[Patent Document 1] Patent No. U.S. Pat. No. 4,336,244

[Patent Document 2] JP Unexamined Patent Publication No 2007-64564

[Patent Document 3] JP Unexamined Patent Publication No. 2009-91386

[Patent Document 4] JP Unexamined Patent Publication No. 2011-106733

### SUMMARY OF THE INVENTION

### An Object to be Solved by the Invention

The present invention has been made to solve such the problems, and its object is to provide a heating medium generating apparatus and heating treatment apparatus in order correspond to the demand for lower prices a It is also an object. of the present invention to achieve energy savings, weight saving and shortening of manufacturing process and time of the apparatus.

### Means for Solving the Objects

To achieve the above object, the first aspect of the present invention is to have a heating medium generating apparatus comprising:

an exterior body having a heat insulating property;

far-infrared radiation heater disposed on the exterior body;

a heat exchange pipe disposed toward the other end from one end of the exterior body, provided with a water discharge portion and a water supply portion, and heating medium supplied water passes through the inner space; and as first reflection member reflecting far-infrared rays emitted from the far infrared radiation heater, and capable of emitting to the heat exchange pipe again.

According to the present invention, radiant heat transfer system using a far-infrared radiation heater is adopted in place of the conduction heat transfer system using conventional electrically-heated wire and the heat conducting cement as a heat exchange system of the heating medium, and also adopts such constitution that radiant heat of a far-infrared rays can be emitted repeatedly by reflection of the radiant heat.

Thus since it was possible to reduce the manufacturing cost and also achieved simplification of apparatus manufacturing process, a significant cost reduction is realized.

Further, as in the present invention, provision of the first reflection member enable not only radiates radiant heat of far-infrared rays to heat exchanger pipe simply on a one-way, but also radiates radiant heat of far-infrared rays to heat exchanger pipe again by reflection of the first reflecting member, and thereby the heat transfer efficiency is high, energy saving is done and weight saving of the entire apparatus and shortening the manufacturing time of the apparatus are done owing to non-use of the heat conducting cement as before.

The second aspect of the present invention is the heating medium generating apparatus according to the first aspect of the present invention, wherein the far-infrared radiation heater is formed in a rod-like shape, disposed at the center position of the internal space over from one end of the exterior body to the another end, the heat exchanger pipe is formed in coil state, is left a predetermined space with the far-infrared radiation heater, and is arranged in circular wound in the longitudinal direction of the far-infrared radiation heater, and the first reflecting member is formed of the whole tubular shape covering the entire area in the direction of the length of the heat exchange pipe and is arranged at a predetermined interval with the heat exchange pipe.

According to the present invention, the heat exchange pipe formed in a coil shape around the far-infrared radiation beater of the rod-like arranged in the center of the exterior body is arranged, the first reflecting member in a tube shape cover the same with a predetermined spacing with the heat exchange pipes and thereby heat radiated from the far-infrared radiation heater is transferred to the heating medium in the pipe through the heat exchanger pipe.

The radiant heat passing through the heat exchanger pipe is reflected by the first reflecting member, passes through the heat exchanger pipe again, and is transferred to the heating medium in the pipe.

With the configuration of the present invention as described above, the heat radiated from the far-infrared radiation heater is repeatedly transferred to the heating medium through the heat exchanger pipe and thus heat transfer efficient effect is exerted.

The third aspect of the present invention is the heating medium generating apparatus according to the first aspect or the second aspect, wherein the exterior body is formed in the whole tubular shape that its inside is an enclosed space between the external tube and a heat insulating material provided with the inner surface of the external tube.

According to the present invention, because inside of exterior body may be an enclosed space having a heat insulating property, it is possible to improve an efficiency of heat transfer by effective utilization of radiant heat of the far-infrared radiation heater without losing the radiant heat to outside thereof.

The fourth aspect of the present invention is the heating medium generating apparatus in the third aspect, wherein the first reflecting member is formed in a tubular shape, and is disposed on the inner surface of the insulation.

According to the present invention, since the first reflecting member is formed into a tubular shape, radiation heat from the far-infrared radiation heater reflect off surface portion of the tubular shape and then return to the heat exchange pipe and thereby the heat transfer is highly effective.

The fifth aspect of the present invention is the heating medium generating apparatus according to the fourth aspect, wherein inner surface of the first reflecting member is mirror finished.

According to the present invention, since the inner surface of the first reflecting member is mirror finished, reflection efficiency of radiant heat for the first reflecting member is high.

The sixth aspect of the present invention is the heating medium generating apparatus according to any one of the first aspect to the fifth aspect, wherein single far-infrared radiation heater is arranged.

According to the present invention, it is possible to compactify the entire apparatus.

The seventh aspect of the present invention is the heating medium generating apparatus according to any one of the first aspect to the fifth aspect, wherein plural far-infrared radiation heater is arranged.

According to the present invention, since plural far-infrared radiation heater is disposed, heat transfer efficiency in the apparatus is improved.

The eighth aspect of the present invention is the heating medium generating apparatus according to the seventh aspect, wherein a plurality of regions of the first region to the n region extending in longitudinal direction of the inner space is arranged collaterally in the center region of the heat exchanger pipes disposed in the internal space over the length direction of the external body, a far-infrared radiation heater is arranged independently in each of these plural regions, and the each of the regions in which each of the far-infrared radiation heater is arranged is partitioned by the second reflecting member that can reflect far-infrared radiation ray emitted from the far-infrared radiation heater respectively and emit it to the heat exchange pipe again respectively.

According to the present invention, it can radiates not only radiant heat of far-infrared rays to heat exchange pipe a one-way but also radiates the radiant heat of far-infrared rays to the heat exchange pipe again by reflection of the first reflective member, further radiant heat can be emitted to the heat exchanger pipes thereby again reflected by the second reflecting member. Therefore, it follows that the heat transfer by the repeated heat radiation is carried out, the heat transfer efficiency is also increased, it was be measured with high energy saving as a whole.

The ninth aspect of the present invention is the heating medium generating apparatus according to the eighth aspect, wherein the surface of the second reflecting member is mirror-finished.

According to the present invention, the reflection efficiency of the radiation heat is increased and the heat transfer efficiency is increased since the surface of the second reflecting member is mirror-finished.

The tenth aspect of the present invention is the heating medium generating apparatus according to any one of the first aspect to the ninth aspect, wherein a heating medium injection nozzle for injecting the heating medium generated by the heating medium generating apparatus is connected to the water discharge portion, the heating medium is controlled in the range of 0.01 MPa to 0.30 MPa and 150° C. to 105° C. in the injection nozzle, the heating medium is a gas-liquid mixture consisting of steam and hot water generated in the heat exchanger pipe by boiling feed water supplied to the heat exchanger pipe at the predetermined temperature and predetermined pressure, and the heating medium is injected into the heating treatment chamber through the heating medium injection nozzles, and whereby the heating treatment chamber is adjusted to the heating treatment atmosphere of a mixed state of superheated steam and high-temperature fine water droplets.

According to the present invention, the use of the heating medium generating apparatus of the present invention may correspond to the demand for compactification and price reduction of the heating treatment apparatus as a whole.

### Effect of the Invention

According to the present invention, it became possible to provide a heating medium generating apparatus and a heating apparatus that may correspond to the demand for compactification and price reduction. Further, according to the present invention, it became possible to achieve energy savings, weight saving and shortening of manufacturing process and time of the apparatus.

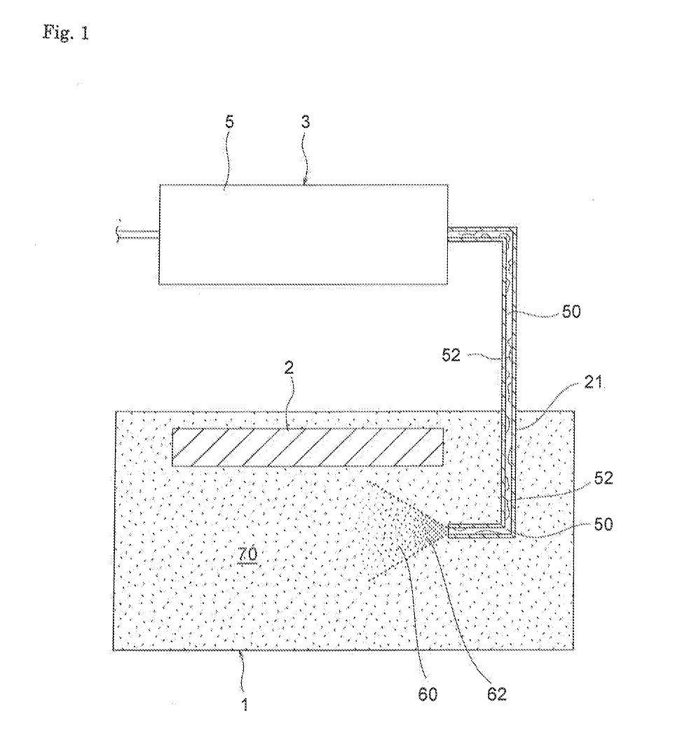

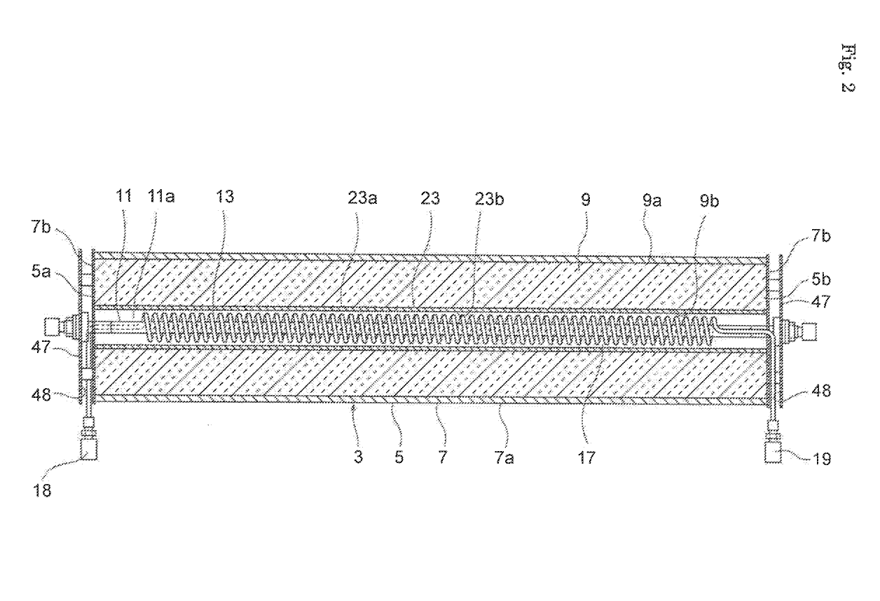

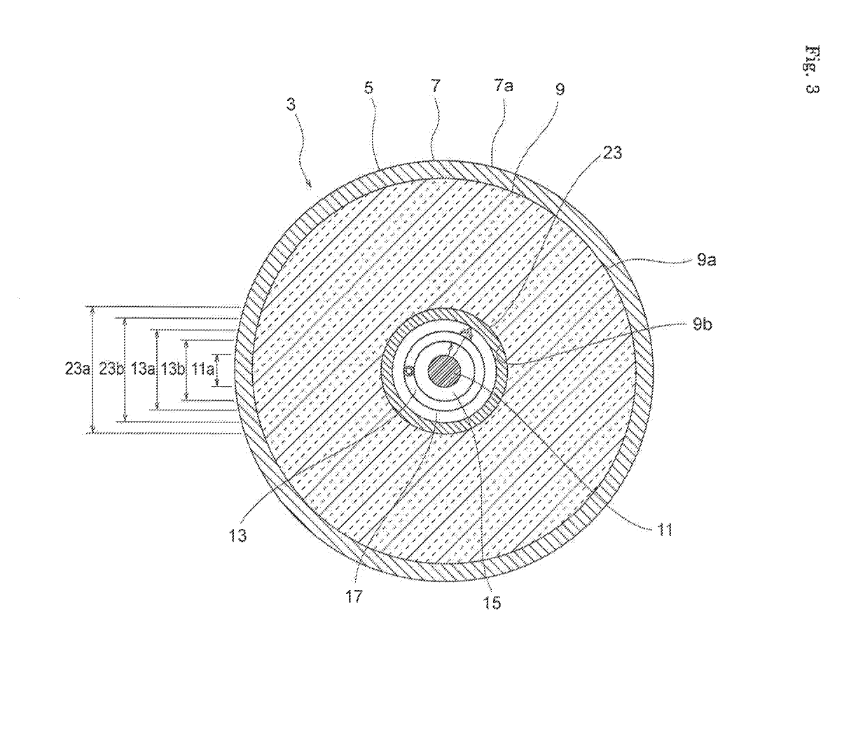

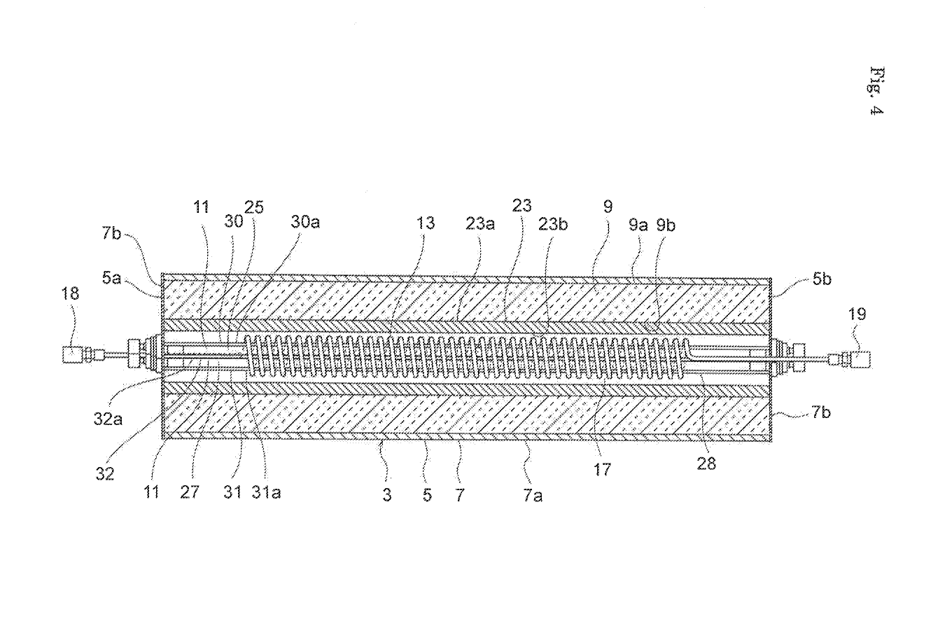

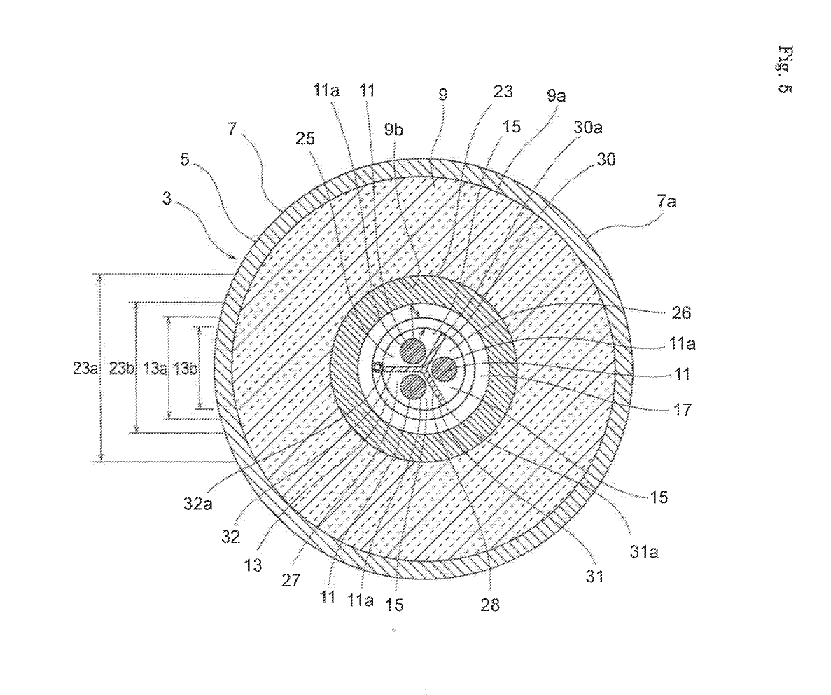

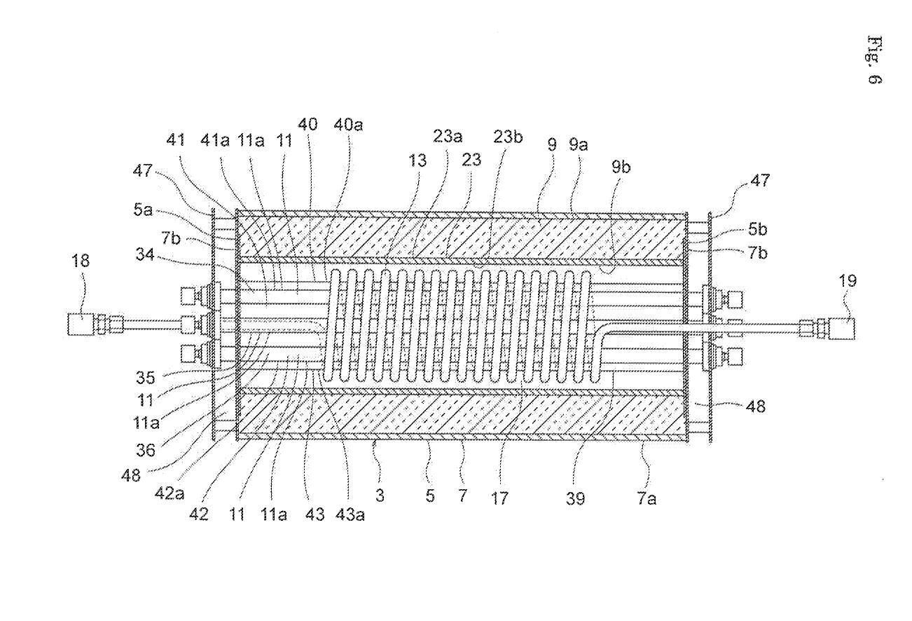

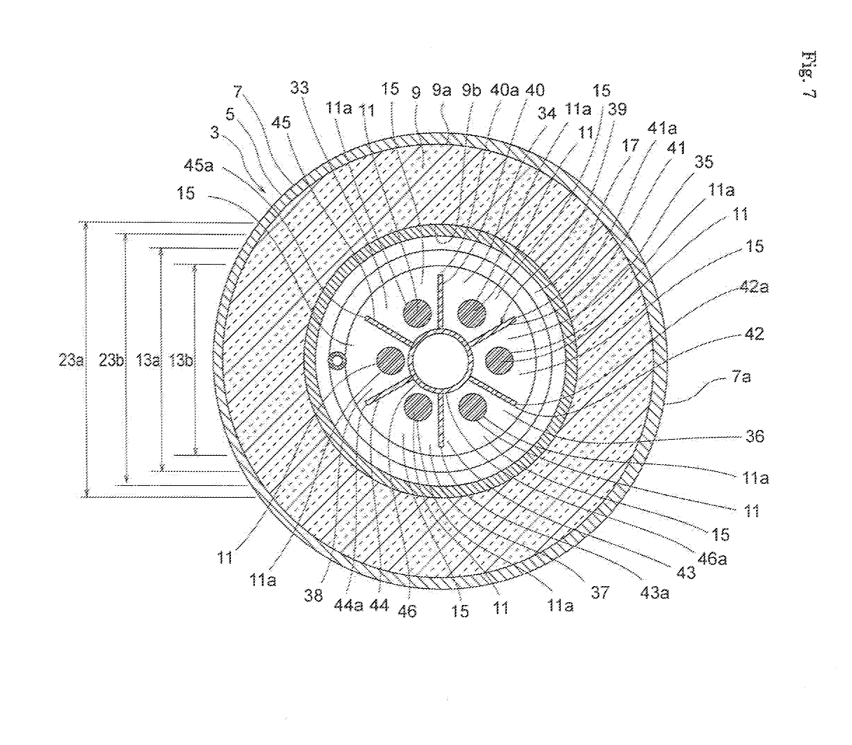

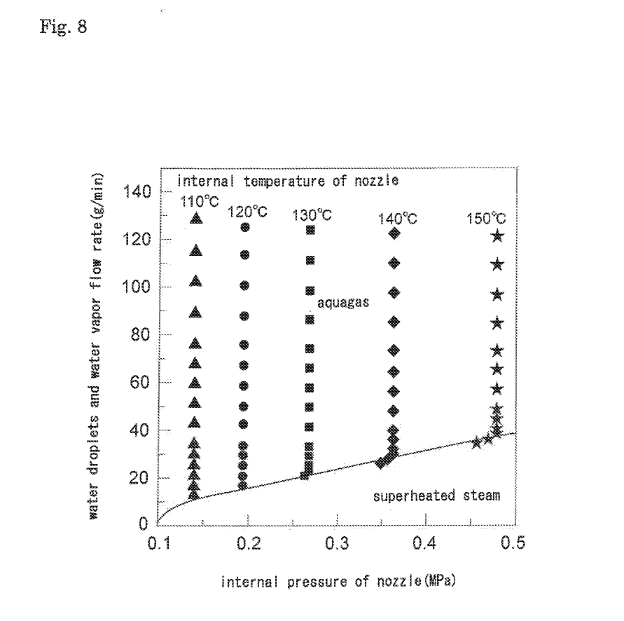

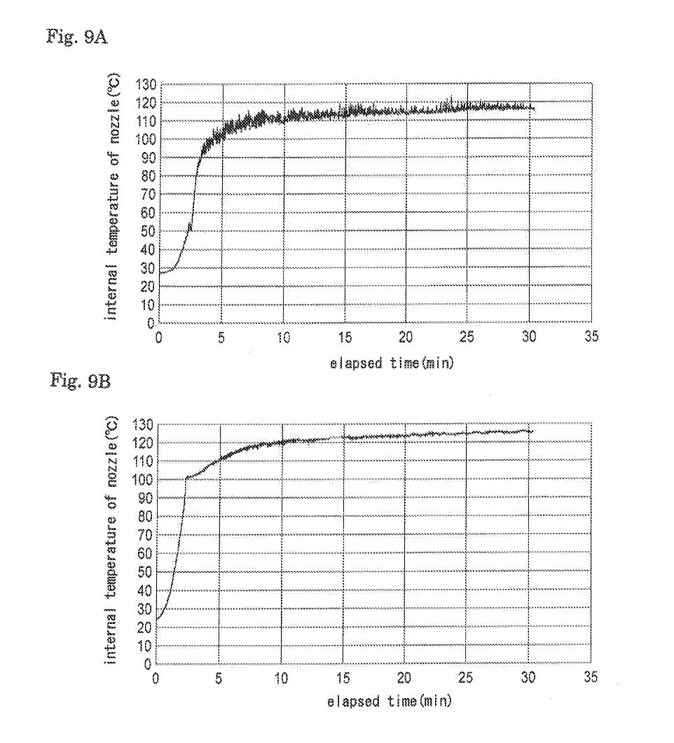

### BRIEF DESCRIPTION OF THE DRAWINGS

[FIG. 1] A schematic front view showing an embodiment of a heating treatment apparatus of the present invention;

[FIG. 2] A schematic front view is shown in a partial cross-sectional view a first embodiment of the heating medium generating apparatus of the present invention;

[FIG. 3] A schematic side view partially showing cross section of a first embodiment of the heating medium generating apparatus of the present invention;

[FIG. 4] A schematic front view partially showing cross-section of a second embodiment of the heating medium generating apparatus of the present invention;

[FIG. 5] A schematic side view partially showing cross section of a second embodiment of the heating medium generating apparatus of the present invention;

[FIG. 6] A schematic front view partially showing cross section of a third embodiment of the heating medium generating apparatus of the present invention;

[FIG. 7] A schematic side view partially showing cross section of a third embodiment of the heating medium generating apparatus of the present invention;

[FIG. 8] A graph showing the relationship between the water vapor and water droplets flow rate curve and the internal pressure in the nozzle which is connected to the heating medium generating apparatus of the present invention;

[FIG. 9] Graphs showing comparison of the nozzle temperature control stability is connected to each of the heating medium generating apparatus of the conventional art and the present invention, FIG. 9A showing the case of the heating medium generating apparatus of the conventional art using electrically-heated wire and FIG. 9B showing the case of the heating medium generating apparatus of the present invention.

### MODES FOR CARRYING OUT THE INVENTION

The followings are explanation of an embodiment of a heating medium generating apparatus and a heating treatment apparatus using the heating medium generating apparatus of the present invention. It is not intended to be limited thereto in an construed merely one example of the present invention, the present embodiment is designed changeable within the scope of the present invention.

### Embodiment 1

FIG. 1 is a schematic diagram showing an example of a heating treatment apparatus of the present invention using the heating medium generating apparatus of the present invention, FIG. 2 to FIG. 7 are schematic diagram showing an example of a heating medium generating apparatus of the present invention.

A heating treatment apparatus is composed of

a heating treatment chamber 1,

a processing chamber heating mechanism 2 for heating inside of the heating treatment chamber 1 to a predetermined temperature, and

a heating medium generating apparatus 3 injecting a heating medium to heating treatment chamber 1 (see FIG. 1).

For example, heating treatment chamber 1 is formed in a rectangular shape having a predetermined length and a non-sealed shape and provided with a charging port (not shown) to put the processing object (see FIG. 1).

And the entire length, overall shape, structures of heating treatment chamber 1 is designed changeable within the scope of the present invention.

Further, the heating chamber 1, as described below, is formed by selecting a material having a heat insulating property (a heat insulating material) in order to control heating the indoor space to a predetermined temperature above.

Heating chamber 1, as long as it has a configuration for heating control process to the predetermined temperature above the indoor space, for example, provided with an inlet at one side and a discharge port at another side of the processing chamber 1 which includes a transport mechanism such as chain conveyor enable to transport the object to be processed over the inlet to the outlet, which are configured so as to enable a continuous process of the object, it is within the scope of the present invention.

For example, the process chamber heating mechanism 3 is assumed well known room heater. In the present embodiment, the entire heating chamber 1 has been heating control to about 105° C. to 150° C. (about 115° C. preferably) at atmospheric pressure by this processing chamber heating mechanism (room heater) 3.

Note that shape, structure and distribution quantity of the process chamber heating mechanism 3 can be properly changed, it is not intended that whatever the present embodiment is not limited interpretation.

Heating medium generating apparatus 3 adopts the following configuration in the present embodiment.

The heating medium generating apparatus 3 is composed of

the exterior body 5 having a thermal insulation;

far-infrared radiation heater 11 disposed in the exterior body 5 and heat-transferring to the heating medium feed water supplied to the heat exchanger pipe 13 (described later);

the first reflecting member 23 reflecting the far-infrared ray radiated from the far-infrared radiation heater 11 and enabling to radiate it to the heat exchanger pipe 13 again;

the exterior water supply portion 10 provided to the side one end 5a of the exterior member 5 and the exterior water discharge portion 19 provided to the side the other end 5b of the body 5;

the heat exchange pipe 13 being disposed continuously over the water supply unit 18 and the water discharge portion 19 from one end 5a toward the other end 5b of the exterior body 5;

generate heated medium by boiling feed water for heating medium supplied through interior space at the radiant heat (predetermined temperature) from the far-infrared radiation heater 11 and at a predetermined pressure (see FIGS. 1 to 3).

The exterior body 5 is, for example, formed on the whole tubular shape having a heat insulating property, and its inner is sealed space by external tube 7 formed in a tubular shape with the predetermined length and a predetermined diameter (outer diameter and inner diameter) and a heat insulating material 9 provided in a tubular shape on the inner surface of the external tube 7.

The external tube 7 is formed into a tubular shape with non-open at each end with a predetermined metal material. In the present embodiment, it is formed into a tubular shape and its both ends is non-open and the disk-shaped lid portion 7b the left and right of for closing the tube main body 7a of the open-ended form, the ends of the tubular main body 7a, by and 7b, and the non-open at both ends.

And total length, shape overall, external tube diameter and inner tube diameter of the external tube 7 is designed changeable within the scope of the present invention. Further, it is not intended to be construed in any way limiting the material be designed changeable within the scope of the present invention.

Heat insulating material 9 is formed in a tubular shape having a predetermined inner diameter and trade of glass wool, polyurethane foam and so on, and is provided in intimate contact with the inner surface of the external tube 7. The heat insulating material 9 is those well known used within the scope of the present invention and may be modified as within the scope of the present invention as well as quality and thickness (the thickness between the outer diameter 9a and inner diameter 9b) of the tubular material. The heat insulating material 9 is necessary to be disposed with a thickness so as to have a thermal insulation predetermined as exterior body 5, and needs to be configured to allow far-infrared radiation heater 11, the heat exchange pipe 13 and the first reflective plate 23 to be disposed inside the follow thereof.

Far-infrared radiation heater 11 is formed into a single straight rod-like with a predetermined length and predetermined diameter and is disposed at the center of the internal space of the exterior body 5 over from one end 5a to the other end 5b of the exterior body 5 (see FIGS. 2 and 3).

In the present embodiment, it is assumed one embodiment that the single far-infrared radiation heater 11 is disposed.

Further, it is assumed that the far-infrared radiation heater 11 is an electric type far-infrared radiation heater 11 in this embodiment, however the far-infrared radiation heater 11 for the present invention can be a Gas type or electric type and thus within the scope of the present invention and well known can be adopted.

The heat exchange pipe 13 consists of a metal hollow pipe with a predetermined inner diameter in order to pass feed water for heating medium through the inner space thereof, is formed in the coiled state by winding at a predetermined pitch and at a predetermined number, and is arranged in the winding circular along in the longitudinal direction of the far-infrared radiation heater 11 at intervals 15 given with the outer periphery (outer diameter 11a) of the far-infrared radiation heater 11 (see FIGS. 2 and 3).

The heat exchange mime 13 is also arranged with predetermined space 17 between the first reflecting member 23 to be described later (see FIG. 2).

For interval 15 of the heat exchange pipe 13 and the outer periphery of the far-infrared radiation heater 11, the distance from the center point of the far-infrared radiation heater 11 to the center point of the heat exchange pipe 13 is about 1 to 20 mm, 10 to 13 mm is preferably efficient, the distance from he center point of the heat exchange pipe 13 to the inner surface of the first reflecting member 23 is about 1 to 18 mm, efficient is 2 to 5 mm preferably.

In other words, it has the relationship between an outer diameter 11a of the far-infrared, radiation heater 11<coil 13b of the inner diameter of heat exchange pipe 13, and outside diameter of coil 13a of the heat exchange pipe 13<the inner diameter of 23b of the first reflecting member 23 (see FIG. 3).

The material of the heat exchange pipe 13 is not limited particularly and it is preferable to adopt a metal material having a high thermal conductivity.

The heat exchange pipe 13 in the present embodiment is given heat-resistant black paint, thereby the heat absorption rate is increased.

Then, at one end of the heat exchange pipe 13, a water supply portion (the water supply port) 18 for connecting a water supply source (not shown) and the heat exchanger pipes is provided, at the other end, the water discharge portion (water discharge port) 19 is provided, the water discharge portion 19 is connected with heating medium injection nozzle 21 for injecting the heating medium generated by the heat exchange pipe 13 into the heating treatment chamber 1 from the heat exchange pipe 13 (see FIGS. 1 and 2).

Note that in this embodiment, for example, nozzle inner diameter of the heating medium injection nozzle 21 is 0.1 mm to 10 mm (0.5 mm to 5 mm, preferably).

The first reflecting member (reflection tube) 23 is tubular member made of metal hollow having an outer diameter 23a of predetermined disposed snug against the inner surface of the insulator 9 (inner diameter 9b) and is formed on the whole tubular shape covering the entire area in the direction of length of heat exchange pipe 13.

Further, it has a possible inner diameter 23b of placing at predetermined intervals 17 between the heat exchanger pipe 13. In other words, it has a relationship of the inner diameter 23b of the first reflecting member 23>coil outer diameter 13a of heat exchange pipe 13 (see FIG. 3).

Further, it is preferable for enhancing the reflection efficiency of radiant heat, the inner surface of the first reflecting member 23 (inner diameter 23b) is mirror finished.

According to the present embodiment, the supply water for the heating medium is supplied to the heat exchanger pipe 13 by passing through the water supply unit (water supply port) 18 from the water supply source through (assuming an electromagnetic metering pump, for example) a predetermined pumps which is not shown. It is boiled by the predetermined pressure and heat radiated from the far-infrared radiating heater 11 in heat exchange pipe 13 having a predetermined diameter.

The amount of water supplied to the heat exchange pipe 13 is adjusted by the diameter of pipe and the length of pipe, but in this embodiment, for example 0.7 gr/sec or more, and 0.7 gr/sec to 25 gr/sec preferably. Heating medium supply water will be heated, in a state where a predetermined pressure is applied thereby.

The operation of the heating treatment apparatus of the present invention is described as below.

First, the heating medium supply water supplies through the water supply unit 18 by a metering pump from the water supply source 0.7 gr/sec to the heat exchange pipe 13 of the heating medium generating apparatus 3.

Heat radiated from the far-infrared radiation heater 11 heat transfer to the heat exchange pipe 13 and heats the pipe 13 by itself, is transmitted through the radiant heat pipe 13 to the feed water for heating medium which is supplied to the pipe 13.

Furthermore, the radiation heat pass through the heat exchanger pipe 13, reflect by the first reflecting member 23, pass through the pipe 13 and thereby the heat transfer supplied to the water again.

In this manner, by boiling the supply water a predetermined temperature, for example, at 120° C. (preferably 105° C. to 150° C.) and a predetermined pressure, for example, 0.19 MPa (preferably, 0.01 MPa to 0.30 MPa) gas-liquid mixture (heating medium) consisting of steam 50 and hot water 52 is generated in the replacement pipe 13 (See FIG. 1).

Then, electing the gas-liquid mixture (steam 50 and hot water 52) into the heating treatment chamber 1 where it is controlled heating at 115° C. approximately as described above, by through the heating medium injection nozzle 21, and the heating treatment is adjusted to the heating treatment atmosphere 70 filled with a heating medium in a state where superheated steam 60 and hot fine water droplets 62 are mixed in the heating treatment chamber 1 (see FIG. 1).

In the heating treatment of the treatment object, the gas-liquid mixture (steam 50 and hot water 52) may be injected continuously or may be injected intermittently.

According to this embodiment, heat radiated from the far-infrared radiation heater 11 is heat-transferred to the heating medium in the pipe 13 by passing through the heat exchange pipe 13 with increased heat absorption efficiency by applying a black heat-resistant paint, radiant heat passing through the heat exchange pipe 13 and further, transfer heat to the heating exchange pipe 13 and through the heat exchange pipe 13 again reflected by the first reflecting member 23 (mirror-finished). Arrows in this Fig. shows an example of the radiation direction of the radiation heat.

In this way, since heat radiated from the far-infrared radiation heater 11 is repeatedly transferred to the heating medium supply water through the heat exchange pipe 13, efficient heat-transfer effect is exerted and thus it can heat the heating medium supply water in a short time and generate a heating medium.

Namely, it can not only radiates radiant heat emitted from far-infrared rays to heat exchange pipe 13 a one-way but also radiates the radiant heat emitted from far-infrared rays to the heat exchange pipe 13 again by reflection of the first reflective member 23, so that the heat transfer efficiency is also increased and the generation of the heating medium can be made in a short time.

Therefore, energy savings (cost reduction) can be achieved as a whole.

Further since it does not employ a heat conducting cement as in the prior art, shortening of manufacturing time for apparatus and weight of the entire apparatus can be achieved. Specifically, for example, if it is compared with the heating treatment apparatus using the heating medium generating apparatus (conventional heating medium generators) disclosed in Patent Document 4 using electrically-heated wire by the present inventors, according to the heating treatment apparatus using a heating medium generating apparatus 3 in this example, the manufacturing cost can be saved more than 60%, and be measured energy saving of 40%, downsizing by 50%.

Further, in this embodiment, the circular plate 47, 47 having the same diameter lid 7b, 7b is equipped so as to oppose respectively (outwardly in the longitudinal direction of the tube) at the outer side of the lid portion 7b of the external tube 7.

The circular plate 47 is fixed with each end portion of the far-infrared radiation heater 11. And, a predetermined gap 48, 48 are formed respectively between the disc 47 and the lid 7b, and between the disc 47 and the lid 7b for the purpose of waste heat from the far-infrared radiation heater 11.

FIG. 8, in the heating medium generating apparatus 3 according to the present embodiment, set the temperature of the heating medium injection nozzle 21 which is connected to the heat exchange pipe 13 to 110° C., 120° C., 130° C., 140° C., 150° C., shows the relationship between the internal pressure (MPa) and the feed water (g/min) of the nozzle 21 when it is varied to the extent 14 g-140 g per minutes.

Mark “▴” in Fig. shows relationship between the internal pressure (MPa) and the feed water (g/min) of the nozzle 21 at the time of 110° C. temperature of the nozzle 21,

Mark “” in Fig. shows relationship between the internal pressure (MPa) and the feed. water (g/min) of the nozzle 21 at the time of 120° C. temperature of the nozzle 21,

Mark “▪” in Fig. shows relationship between the internal pressure (MPa) and the feed water (g/min) of the nozzle 21 at the time of 130° C. temperature of the nozzle 21,

Mark “♦” in Fig. shows relationship between the internal pressure (MPa) and the feed water (g/min) of the nozzle 21 at the time of 140° C. temperature of the nozzle 21, and

Mark “★” in Fig. shows relationship between the internal pressure (MPa) and the feed water (g/min) of the nozzle 21 at the time of 150° C. temperature of the nozzle 21,

For example, in the case that the temperature of the nozzle 21 is 110° C., the amount of water supply is gradually increased, after the internal pressure of the nozzle 21 has reached. the 0.142 MPa at the stage it has reached to 11.04 g per minute, heating medium (gas-liquid mixture consisting of the water vapor 50 and a hot water 52) is generated.

Similarly, in the case that the temperature of the nozzle is 120° C., the amount of water supply is gradually increased, after the internal pressure of the nozzle has reached the 0.186 MPa at the stage it has reached to 16.53 g per minute, heating medium (gas-liquid mixture consisting of the water vapor 50 and a hot water 52) is generated.

Similarly, in the case that the temperature of the nozzle is 150° C., the amount of water supply is gradually increased, after the internal pressure of the nozzle has reached the 0.476 MPa at the stage it has reached to 36.85 g per minute, heating medium (gas-liquid mixture consisting of the water vapor 50 and a hot water 52) is generated.

The term “water droplet” depicted in FIG. 8 is synonymous as the term “hot water” in the present specification.

According to the heating medium generating apparatus 3 in the present embodiment, although the generation amount of the heating medium is obtained in the temperature 110° C. to 150° C. of the nozzle 21 has been shown, it is found the generation amount of the heating medium is obtained in that wide temperature (105° C. to 150° C.).

FIG. 9 is the diagram showing the heating rate and the control stability of the nozzle 21, FIG. 9A is the heating treatment apparatus using a conventional heating medium generating apparatus, and FIG. 9B represents the data of each of the heating treatment apparatus using a heating medium generating apparatus.

Conventional heating medium generating apparatus in FIG. 9A is the maximum output 4.96 kw, the heating medium generating apparatus of the present embodiment in FIG. 9B is the maximum output 2.0 kw, equivalent, performance was confirmed in rising speed of temperature in the same amount of water supply.

Furthermore, the case of using the heating medium generating apparatus 3 of the present embodiment can obtain highly accurate temperature control is stable as compared with the case of using the heating medium generating apparatus of the prior art was also demonstrated.

### Embodiment 2

FIGS. 4 and 5 show the heating medium generating apparatus, a second embodiment of the present invention, it is assumed that an example of this embodiment is the embodiment that three far-infrared radiation heater 11, 11, 11 are disposed in a single apparatus 3.

In the center region of the coil shape of the heat exchange pipe 13 that is disposed over the longitudinal direction of the exterior member 5, a first region 25 to the third region 27 extending longitudinally of the internal space of the coil shape is parallel arranged, the far-infrared radiation heater 11, 11, 11 are provided independently to the 25 to 27 region thereof respectively

The first region 25 to the third region 27 are formed so as to be partitioned by a second reflecting member 28 that reflects each of the far-infrared rays radiated from the far-infrared radiation heater 11 and that capable of emitting respectively into the heat exchange pipe 13 again.

Second reflecting member 28 is provided with a partition plates 30, 31 and 32 so that the first region 25, second region 26, third region 27 may be as evenly spaced every 120 degrees.

The respective partition plates 30, 31, 32 are formed by combining the base end side so that region may be divided evenly every 60° respectively. That is, it is up edge formed at a predetermined height and, in the same length as the external tube 7 in the longitudinal direction of the external tube 7.

In the present embodiment, it is set at a height enough to contact the inner surface (inner diameter 13b) of the heat exchange pipe 13 having a coil shape with the upper end (the free end) 30a, 31a, 32a of each partition plates 30, 31, 32.

Surface of the second reflecting member 28, that is, the surface of the partition plates 30, 31, 32, are mirror-finished, respectively.

Therefore, in the present embodiment, second reflecting member 28 in center thereof, first region 25 to the third region 27, the far-infrared radiation heater 11, 11, 11, the heat exchange pipe 13, the first reflecting member 23, heat insulating material 9, and are disposed outward from the inside in the order of the external tube 7.

According to the present embodiment, the heat exchange pipe 13 transfer heat to the feed water radiant heat from the far-infrared radiation heater 11, 11, 11 the to pass through, respectively, and flows through the inner pipe 13.

Then, according to the present embodiment, the radiation heat passed through the heat exchange pipe 13, transfer heat to the feed water through the heat exchange pipe 13 again by reflection of the first reflection member 23.

Furthermore, radiant heat passing through the heat exchange pipe 13, heat transfer to the feed water through the heat exchange pipe 13 again and is reflected by the partition plates 30, 31 and 32 of the second reflecting member 28.

Thus, the far-infrared radiation heaters 11, 11, 11 in respective order as well surrounded by a second reflecting member 28 and the first reflection member 23, the heat exchange pipe 13 is passing through the area surrounded, the above such action is carried out repeatedly, the heat transfer efficiency is very high and can generate heating medium in a short period of time. Arrows in the Fig. shows an example of the radiation direction of the radiation heat.

Further, in this embodiment, although the form which is in contact the inner surface (inner diameter 13b) of the heat exchange pipe 13 having a coil shape with the upper end (the free end) 30a, 31a, 32a of the 30, 31, 32 partition plate respectively, it may be possible in non-contact and is also within the present invention.

The thickness of the partition plates 30, 31 and 32 is not particularly limited and can be changed within the scope of the present invention. In the present embodiment, the partition plates 30, 31, 32 is a continuous single plate member, but may be divided into a plurality of lengthwise and in he form disposed intermittently.

The present embodiment's characteristic feature is forming a first region 25 to third region 27 provided with the second reflecting member 28, a far-infrared radiation heater 11 is provided with each of the regions 25 to 27 respectively, however the other structure and operation effects are omitted because a detailed description thereof will be the same as in the first embodiment.

### Embodiment 3

FIGS. 6 and 7 show a third embodiment of the present invention, the heating medium generating apparatus 3, in this embodiment, it is assumed an example that provided 6 sets of the far-infrared radiation heater 11, 11, 11, 11, 11, 11 in the single apparatus 3.

In the center region of the coil shape of the heat exchange pipe 13 that is disposed over the longitudinal direction of the exterior member 5, the first region 33 to the sixth region 38 extending longitudinally of the internal space of the coil, shape are arranged, the far-infrared radiant heater 11, 11, 11, 11, 11, 11 are arranged one by one independently to the 33-38 region thereof.

The first region 33 to the sixth region 38 reflects each far infrared radiation rays emitted from the far-infrared radiation heater 11, 11, 11, 11, 11, 11, and is constituted by being divided by the second reflecting member 39 capable of emission respectively to the heat exchange pipe 13 again.

A second reflecting member 39 is provided with plates 40, 41, 42, 43, 44, 45 so that the first region 33, second region 34, third region 35, the fourth region 36, the fifth region 37, and the sixth region 38 may be partitioned as evenly spaced every 60 degrees respectively.

In the present embodiment, the pipe 46 is provided in the center with a length over the second end portion 7b from one end 7a of the external tube 7, the partition plates 40, 41, 42, 43, 44, 45 integrally formed raised edge to constitute a second reflecting member 39 at predetermined intervals from the outer diameter 46a of the pipe 46.

Partition plates 40, 41, 42, 43, 41, 45 are formed to be raised edge from the axial center of the pipe 46 at locations evenly spaced every 60 degrees respectively. That is, the outer diameter of the pipe 46 is formed raised up at a predetermined height and same length as the pipe 46 in the longitudinal direction of the pipe 46.

Reasons for the embodiment having a pipe 46 in this way, possible to be capable of far-infrared radiation heaters 11 . . . is to arrange in a state of forming a space around it in the space of 33-38 region of each. This is used to form a wide space limit.

Surface of the second reflecting member 39, that is, the surface of the 40, 41, 12, 43, 44, 45 each partition plate is mirror-finished, respectively.

The thickness of the partition plate 40, 11, 12, 13, 44, 45 are not particularly limited and design modifiable within the scope of the present invention. Further, in the present embodiment, the height of the partition plate 40, 41, 42, 43, 44, 45 is set to all the same, but a different height may be possible.

In the present embodiment, the partition plate 40, 41, 42, 43, 44, 45 is a plate member of one each continuous, but it may be acceptable in the form disposed intermittently and divided into a plurality in the longitudinal direction.

Therefore, in the present embodiment, second reflecting member 39 as center thereof, the first region 33 to the sixth region 38, each of the far-infrared radiation heater 11 . . . heat exchange pipe 13, the first reflecting member 23, the heat insulating material 9, the external tube 7, are disposed outward from the inside.

According to the present embodiment, radiant heat from the far-infrared radiation heater 11 . . . flows through the heat exchange pipe 13 respectively, and transfer heat to the feed water to pass through the heat exchange pipe 13.

Then, according to the present embodiment, the radiation heat passed through the heat exchange pipe 13, is reflected by the first reflection member 23 and transfer heat to the feed water through the heat exchange pipe 13 again.

Furthermore, radiant heat passing through the heat exchange pipe 13 is reflected by the partition plates 40, 41, 42, 43, 44, 45 of the second reflecting member 39, transfer heat to the feed water through the heat exchange pipe 13 again.

Thus, the far-infrared radiation heaters 11, 11, 11 in respective order as well surrounded by the first reflection member 23 and the second reflecting member 39, the heat exchange pipe 13 is passing through this area surrounded, the above such action is carried out repeatedly, the heat transfer efficiency is very high and can generate heating medium in a short period of time. Arrows in the Fig. shows an example of the radiation direction of the radiation heat.

Further, in this embodiment, unlike in Embodiment 2, the upper end (free end) 40a, 41a, 42a, 43a, 44a, 45a of the partition plate 40, 41, 42, 43, 44, 45 respectively have a coil shape and is a non-contact mode with the inner surface (inner diameter 13b) of the heat exchanger pipe 13, but it is possible for the present invention to be in the form of contact with the inner surface (inner diameter 13b) of the heat exchange pipe 13 and within scope of the present invention.

The present embodiment's a characteristic feature is forming a first region 33 to six region 38 provided with the second reflecting member 39 a far-infrared radiation heater 11 is provided with each of the regions 33 to 38 respectively, however the other structure and operation effects are omitted because a detailed description thereof will be the same as in the first embodiment.

The above described first embodiment to third embodiment are in the form of one embodiment of the present invention, it is not intended that whatever limited and interpreted thereto, the number of disposed far-infrared radiation heater 11 and the number of the region partitioned by the second reflecting member 26 (39) are all changeable design and within the scope of the present invention.

It was also described to have in Embodiment 2 and Embodiment 3, the embodiment has been disposed single far-infrared radiation heater in each region of a single, but it is also acceptable for plural far-infrared radiation heater in each region of single, they are within the scope of the present invention.

Further, in the present embodiment, it has been described with a form of arranging one of the heat exchange pipes for one of the heating medium generating apparatus, but it is also acceptable plural heat exchanger pipes for plural heating medium generating apparatus, they are within the scope of the present invention.

### INDUSTRIAL APPLICABILITY

In the present specification, the heating medium generating apparatus capable of generating a heating medium heated processable in high quality foods, and the heating treatment apparatus for the heating treatment can be in high quality processing object such as foods and using the heating medium generating apparatus were described. However, the present invention is available in the field of the heating treatment process object using the (gas-liquid mixture) is heated media novel consisting of superheated steam and (hot water) hot fine water droplets, for example in the field of the chemical and pharmaceutical, product granules, such as product (granulated product).

### EXPLANATION OF THE REFERENCE NUMERAL

1 heating chamber

3 heating medium generator

5 exterior body

11 far-infrared radiation heater

13 heat exchange pipe

18 water supply

19 water discharger

21 heating medium injection nozzle

23 first reflecting member

What is claimed is:

1. A heating medium generating apparatus comprising:
an exterior body having a heat insulating property;
far-infrared radiation heater disposed on the exterior body;
a heat exchange pipe disposed toward the other end from one end of the exterior body outer casing, provided with a water discharge portion and a water supply portion unit, and heating medium supplied water passes through the inner space; and
a first reflection member reflecting far-infrared rays emitted from the far-infrared radiation heater, and a and capable of emitting to the heat exchange pipe again.

2. The heating medium generating apparatus according to claim 1, wherein
the far-infrared radiation heater is formed in a rod-like shape, disposed at the center position of the internal space over from one end of the exterior body to the another end,
the heat exchanger pipe is formed in coil state, is left a predetermined space with the far-infrared radiation heater, and is arranged in circular wound in the longitudinal direction of the far-infrared radiation heater, and
the first reflecting member is formed of the whole tubular shape covering the entire area in the direction of the length of the heat exchange pipe and is arranged at a predetermined interval with the heat exchange pipe.

3. The heating medium generating apparatus according to claim 2, wherein the exterior body is formed in the whole tubular shape that its inside is an enclosed space between the external tube and a heat insulating material provided with the inner surface of the external tube.

4. The heating medium generating apparatus according to claim 3, wherein the first reflecting member is formed in a tubular shape, and is disposed on the inner surface of the insulation.

5. The heating medium generating apparatus according to claim 4, an inner surface of the first reflecting member is mirror finished.

6. The heating medium generating apparatus according to claim 1, single far-infrared radiation heater is arranged.

7. The heating medium generating apparatus according to claim 5, single far-infrared radiation heater is arranged.

8. The heating medium generating apparatus according to claim 1, plural far infrared radiation heater are arranged.

9. The heating medium generating apparatus according to claim 5, plural far-infrared radiation heater are arranged.

10. The heating medium generating apparatus according to claim 9, wherein
a plurality of regions of the first region to the a region extending in longitudinal direction of the inner space is arranged collaterally in the center region of the heat exchanger pipes disposed in the internal space over the length direction of the external body,
a far infrared radiation heater is arranged independently in each of these plural regions, and
the each of the regions in which each of the far-infrared radiation heater is arranged is partitioned by the second reflecting member that can reflect far-infrared radiation ray emitted from the far-infrared radiation heater respectively and emit it to the heat exchange pipe again respectively.

11. The heating medium generating apparatus according to claim 10, wherein surface of the second reflecting member is mirror finished.

12. A heating treatment apparatus as a component of the heating medium generating apparatus according to the claim 1, wherein
a heating medium injection nozzle for injecting the heating medium generated by the heating medium generating apparatus is connected to the water discharge portion,
the heating medium is controlled in the range of 0.01 MPa to 0.30 MPa and 105° C. to 150° C. in the injection nozzle,
the heating medium is a gas-liquid mixture consisting of steam and hot water generated in the heat exchanger pipe by boiling feed water supplied to the heat exchanger pipe at the predetermined temperature and predetermined pressure, and
the heating medium is injected into the heating treatment chamber through the heating medium injection nozzles, and whereby the heating treatment chamber is adjusted to the heating treatment atmosphere of a mixed state of superheated steam and high-temperature fine water droplets.

13. A heating treatment apparatus as a component of the heating medium generating apparatus according to the claim 7, wherein
a heating medium injection nozzle for injecting the heating medium generated by the heating medium generating apparatus is connected to the water discharge portion,
the heating medium is controlled in the range of 0.01 MPa to 0.30 MPa and 105° C. to 150° C. in the injection nozzle,
the heating medium is a gas-liquid mixture consisting of steam and hot water generated in the heat exchanger pipe by boiling feed water supplied to the heat exchanger pipe at the predetermined temperature and predetermined pressure, and
the heating medium is injected into the heating treatment chamber through the heating medium injection nozzles, and whereby the heating treatment chamber is adjusted to the heating treatment atmosphere of a mixed state of superheated steam and high-temperature fine water droplets.

14. A heating treatment apparatus as a component of the heating medium generating apparatus according to the claim 9, wherein
a heating medium injection nozzle for injecting the heating medium generated by the heating medium generating apparatus is connected to the water discharge portion,
the heating medium is controlled in the range of 0.01 MPa to 0.30 MPa and 105° C. to 150° C. in the injection nozzle,
the heating medium is a gas-liquid mixture consisting of steam and hot water generated in the heat exchanger pipe by boiling feed water supplied to the heat exchanger pipe at the predetermined temperature and predetermined pressure, and
the heating medium is injected into the heating treatment chamber through the heating medium injection nozzles, and whereby the heating treatment chamber is adjusted to the heating treatment atmosphere of a mixed state of superheated steam and high-temperature fine water droplets.

15. A heating treatment apparatus as a component of the heating medium generating apparatus according to the claim 10, wherein
a heating medium injection nozzle for injecting the heating medium generated by the heating medium generating apparatus is connected to the water discharge portion,
the heating medium is controlled in the range of 0.01 MPa to 0.30 MPa and 105° C. to 150° C. in the injection nozzle,
the heating medium is a gas-liquid mixture consisting of steam and hot water generated in the heat exchanger pipe by boiling feed water supplied to the heat exchanger pipe at the predetermined temperature and predetermined pressure, and
the heating medium is injected into the heating treatment chamber through the heating medium injection nozzles, and whereby the heating treatment chamber is adjusted to the heating treatment atmosphere of a mixed state of superheated steam and high-temperature fine water droplets.

16. A heating treatment apparatus as a component of the heating medium generating apparatus according to the claim 11, wherein
a heating medium injection nozzle for injecting the heating medium generated by the heating medium generating apparatus is connected to the water discharge portion,
the heating medium is controlled in the range of 0.01 MPa to 0.30 MPa and 105° C. to 150° C. in the injection nozzle,
the heating medium is a gas-liquid mixture consisting of steam and hot water generated in the heat exchanger pipe by boiling feed water supplied to the heat exchanger pipe at the predetermined temperature and predetermined pressure, and
the heating medium is injected into the heating treatment chamber through the heating medium injection nozzles, and whereby the heating treatment chamber is adjusted to the heating treatment atmosphere of a mixed state of superheated steam and high-temperature fine water droplets.
